(19) United States
(12) Patent Application Publication
(10) Pub. No.: US 2012/0068902 A1
(43) Pub. Date: Mar. 22, 2012

(54) ELECTRICALLY SMALL ULTRA-WIDEBAND ANTENNA FOR MOBILE HANDSETS AND COMPUTER NETWORKS

(75) Inventors: Nathan Clow, Salisbury (GB); Ivor Leslie Morrow, Swindon (GB)

(73) Assignee: THE SECRETARY OF STATE FOR DEFENCE, Salisbury, Wiltshire (GB)

(21) Appl. No.: 13/375,492

(22) PCT Filed: Jun. 8, 2010
(86) PCT No.: PCT/GB2010/001116

§ 371 Date: Dec. 1, 2011

(30) Foreign Application Priority Data
Jun. 9, 2009 (GB) 0909877.3
Oct. 9, 2009 (GB) 0917682.7

(51) Int. Cl. H01Q 9/36

(52) U.S. Cl. 343/791

(57) ABSTRACT

An antenna arrangement (1020) for use in instantaneous ultra-wideband applications, the arrangement using a coaxial to coaxial aperture connection which increases matching bandwidth with reduced lossy effect. Beneficially the antenna arrangement uses a top loaded disk (27) to increase its capacitive effect. The arrangement is physically small making it useful for use within mobile handsets and computer networks.

### TECHNICAL FIELD OF THE INVENTION

This invention relates to an antenna arrangement and particularly to an electrically small antenna operable across a wide range of frequencies and more particularly to an electrically small antenna suitable for use in instantaneous ultra-wideband applications.

### BACKGROUND TO THE INVENTION

Ultra-wideband (UWB) is a wireless radio technology which allows the user to transmit large amounts of data across a very wide range of frequencies. Ultra-wide band systems have applications in many fields such as high-speed, short range, wireless communication; computer networks; radar and geolocation systems; imaging; and medical systems.

In recent years there has been significant interest in the development of electrically small, but efficient antennas capable of operating across a wide bandwidth or at multiple frequencies, where electrically small is generally considered to mean that an antenna has no dimension larger than λ/10. The ability to monitor the electromagnetic spectrum with a single, electrically small and portable antenna would be highly desirable. Therefore, there is a requirement for an antenna having the following electrical and physical characteristics; compact, lightweight, robust, low cost and an ultra-wideband frequency response covering at least the frequency range 20 MHz-6 GHz. This bandwidth would allow coverage of traditional HF and UHF bands while extending operation to the higher frequency Wireless Local Area Network (WLAN) and future 3G/4G (3-5 GHz) spectrums. However, achieving an electrically small antenna that is reasonably radiation efficient and operates over such a wide bandwidth is challenging and various solutions which claim to optimise different combinations of properties have been proposed. In the past, full coverage has only been achieved by clustering a number of different antennas such as combinations of wire, disk cone and bow-tie antennas; however this requires costly and bulky feed networks. Alternatively, several monopoles of varying heights above a ground plane have been used. However this solution does not provide an instantaneous UWB capability but instead the monopoles work in a stepped time sequence when transmitting and receiving data.

Particular applications such as detection and measurement systems require omni directional radiation patterns. For these applications, in particular, one option is to focus on monopole and dipole antennas and the present invention is a development of the monopole antenna.

It is known that the impedance bandwidth performance of a traditional monopole antenna can be improved by top loading with an additional capacitive sleeve. McLean et al (McLean, J., Foltz, H., and Crook, G. “Broadband, Robust Low-profile Monopole Incorporating Top Loading, Dielectric Loading, and a Distributed Capacitive Feed Mechanism”, IEEE International Symposium on Antennas and Propagation, July, pp. 1962-1965, 1999) proposed the directly connected wire stem feed of a conventional top loaded monopole, with a capacitive sleeve. The proposed aperture coupled wire stem feed to the top loaded monopole exploits the attendant frequency variation in reactance slope, which improves the impedance matching bandwidth. The capacitive sleeve further increases the capacitive effect of the top loaded structure, therefore decreasing the Q factor, which increases bandwidth but with lossy effects. Further enhancement of the matching bandwidth is desirable without the lossy effects.

### SUMMARY OF THE INVENTION

It is an object of the present invention to provide an electrically small antenna arrangement with improved impedance matching bandwidth and reduced lossy effects.

Accordingly the present invention provides an antenna arrangement for use in an UWB network, the antenna arrangement comprising a ground plane, a coaxial feed and an antenna element, wherein the antenna element comprises:

a cylindrical conductive case isolated from the ground plane by a first dielectric material;

a second dielectric material contained within the cylindrical conductive case;

a conductive core extending from the coaxial feed through the first dielectric material and into the second dielectric material; and

a top loaded structure electrically connected to the cylindrical conductive case and electrically insulated from the conductive core,

the antenna element being configured as a shorted coaxial section.

The adoption of a coaxial to coaxial aperture connection permits increased matching bandwidth with reduced lossy effect. The term “coaxial” is used to mean a shielded electrical cable constructed with precise conductor dimensions and spacing in order to function efficiently as a radio frequency transmission line. The coaxial is capable of propagating a transverse electromagnetic wave (TEM), allowing a RF bandwidth in principle of up to 18 GHz to be propagated along the cable. Any abrupt change in the relative dimensions causes increased reflection, reducing the quality of the transmitted power. For this reason it is preferred that the core of the coaxial feed is extended beyond the ground plane to act as the core of the antenna element without need for a change in dimension or a connection of any sort. Top loading the antenna element increases the capacitance effect of the antenna so that the physical structure may be reduced in height. This allows the core of the antenna to act as a monopole feed at less than a quarter wave length in height but does not have the detrimental effect of generating out of phase reflections normally associated with reducing the height below that of λ/4.

In the simplest form of antenna construction the first and second dielectric material used can be air. Surrounding the core of the antenna element with dielectric material increases the vertical current moment and improves radiation efficiency, decreasing feed point reactance and feed point voltage which decreases the Q factor resulting in increased bandwidth capability. The dielectric value of a material depends on its permittivity. The choice of material used relates to its higher or lower capacitive effect. Air has a dielectric value of 1 which is less than PTFE (polytetrafluoroethylene) with a dielectric value of 2 because PTFE has higher permittivity. Increasing the permittivity of the second dielectric material enhances the performance of the antenna arrangement. One particular embodiment of the invention uses air as the first dielectric material and PTFE as the second. A person skilled in the art will appreciate that other combinations of dielectric materials can be used. Furthermore, encasing the antenna element in a third dielectric material can offer further reductions in the Q factor and therefore gains in bandwidth. Also the use of a solid dielectric provides structural support and will enhance robustness.

The top loaded structure can be varied in its shape and construction and can be made from any metallic material. The simplest form is a shorting end cap electrically connected to a cylindrical conductive case (which is comprised from a section of the outer case of a semi rigid coaxial). However, other forms such as wires, spirals and plates etc can be used. The preferred embodiment uses an enlarged “top hat” disc structure. The disc can also be sub divided into a number of discrete sections, like a Goubau top loaded antenna (IEEE Transactions on Antennas and Propagation Vol. AP-30, No. 1, January 1982), with spacing between each section to further improve the capacitance of the antenna arrangement and hence reduce the physical height of the antenna further.

Ensuring there is a gap between the cylindrical conductive case and the ground plane and using air for the first dielectric material allows the increase of the capacitance effect of the antenna arrangement and therefore the bandwidth capability but with reduced lossy effects. Also by adjusting the gaps between the top loaded structure and the end of the conductive core G1 and also between the cylindrical conductive case and the ground plane G2 can allow the antenna arrangement to be fine tuned to ensure the ideal impedance matching bandwidth is obtained.

The antenna arrangement can further include a plurality of radial fins which act as spatial polarisation filters. The fins may comprise fast or slow surface wave structures that act as High Impedance Surfaces. Use of fins reduces the need to surround an antenna with a solid dielectric material. Furthermore the fins act as frequency dependent spatial polarisation filters to aid isolation and directionality of signals. By providing an array, particularly a ring shaped array of such antenna arrangements a direction finding capability can be provided.

By providing a plurality of antenna arrangements of pre-selected differing heights the antenna designer can multiply the bandwidth capability if operated in a stepped sequence.

A wide band Electromagnetic Band Gap (EBG) surface can be assembled by grounding a plurality of antenna arrangements on a metal substrate. In this application the antenna arrangements are scaled to an appropriate sub-wavelength λ10-λ/20 dimension and arranged into a two-dimensional scattering surface, in order to scatter an incident field. Such an electromagnetic band-gap surface exhibits enhanced bandwidth, compared with known EBG surfaces. Furthermore, a number of two-dimensional surfaces may be stacked to form a three dimensional lattice, the electromagnetic band gap of each surface being arranged to be non-identical but overlapping, thus extending the EBG frequency range of operation.

### BRIEF DESCRIPTION OF THE DRAWINGS

The invention will now be described, by way of example, with reference to the accompanying drawings, in which:

FIG. 1 shows a cross sectional illustration of a conventional wideband λ/4 disk loaded monopole antenna arrangement;

FIG. 2 shows the return loss bandwidth response for a conventional wideband λ/4 disk loaded monopole 16 mm in height above the ground plane;

FIG. 3 shows a cross sectional schematic representation of an antenna arrangement in accordance with the invention;

FIG. 4 shows a cross sectional schematic representation of a preferred antenna arrangement in accordance with the invention;

FIG. 5 shows the return loss response of the antenna arrangement illustrated in FIG. 4;

FIG. 6 shows the measured E-plane at 2.4 GHz for the antenna arrangement of FIG. 4;

FIG. 7 shows the measured E-plane at 3.0 GHz for the antenna arrangement of FIG. 4;

FIG. 8 shows the measured E-plane at 3.6 GHz for the antenna arrangement of FIG. 4;

FIG. 9 shows the measured E-plane at 4.2 GHz for the antenna arrangement of FIG. 4;

FIG. 10 shows the measured E-plane at 4.8 GHz for the antenna arrangement of FIG. 4;

FIG. 11 shows the simulated gain results for the antenna arrangement of FIG. 4;

FIG. 12 shows the physical circuit representation of the antenna arrangement of FIG. 4;

FIG. 13 shows the equivalent circuit representation of the antenna arrangement of FIG. 4;

FIG. 14 shows the comparison of circuit model response of FIG. 2 versus the measured return loss of FIG. 4;

FIG. 15 shows a cross sectional schematic representation of the preferred antenna arrangement of FIG. 4 with additional rectangular spatial polarisation fins; and

FIG. 16 shows a cross sectional schematic representation of an antenna array comprising a plurality of antenna arrangements of different heights.

### DETAILED DESCRIPTION

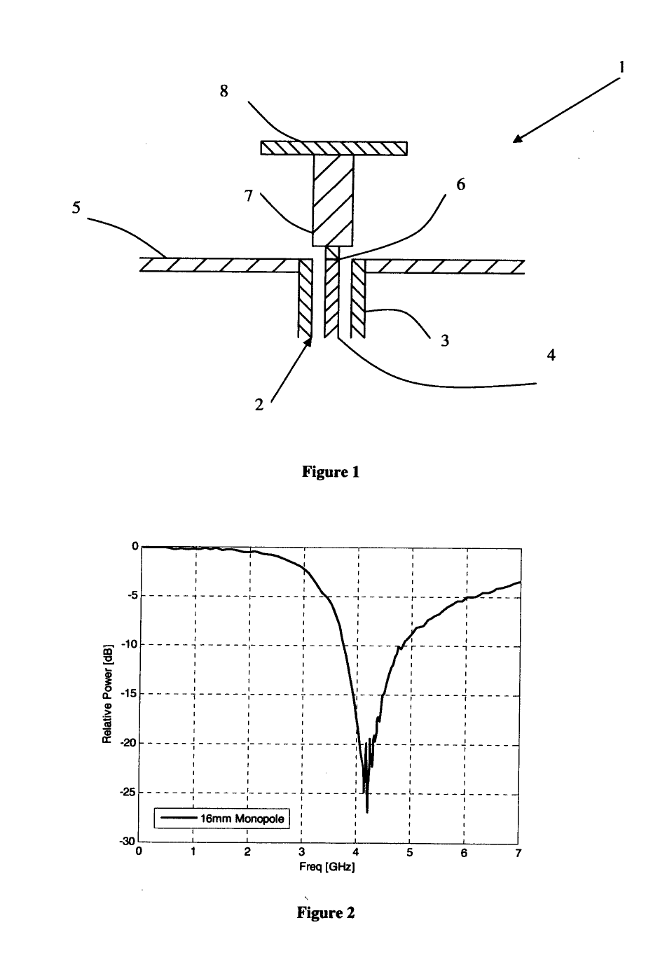

FIG. 1 illustrates a cross section of a top loaded monopole antenna arrangement 1 which represents the prior art. In this arrangement a coaxial feed 2 comprises an outer case 3 and an inner wire 4. The inner wire 4 attaches to an electrical connector 6. A monopole antenna 7 attaches to the other side of the electrical connector 6 which might be a simple solder connection. The outer case 3 is connected to a ground plane 5. A top loaded structure 8 is connected to the end of the monopole antenna 7 which is furthest from the ground plane 5.

The return loss bandwidth response for a conventional wideband λ/4 disk loaded monopole 16 mm in height above the ground plane, is provided in FIG. 2. At 0.5 GHz the graph indicates that 100% of the signal power is being reflected back from the electrical connection of the cable and monopole antenna due to pure impedance matching. Between 3.8 to 4.8 GHz, there is −10 dB gain, indicating that only 5% power is reflected back across a bandwidth of 1 GHz. FIG. 2 can be used for comparison purposes against the performance of the preferred embodiment of the invention as shown in FIG. 4.

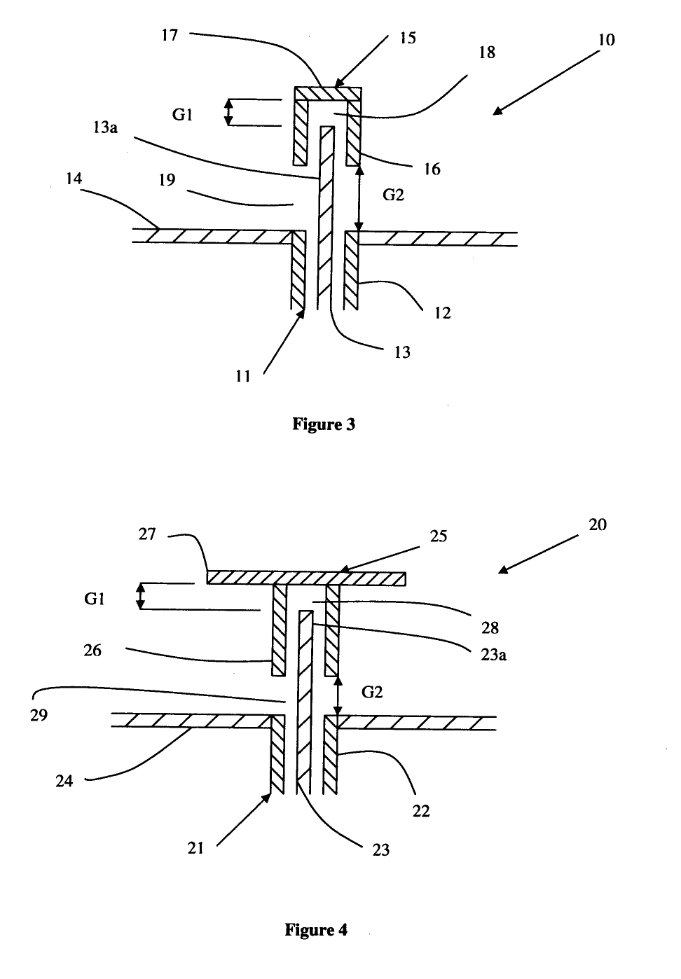

FIG. 3 illustrates a cross section schematic representation of one embodiment of an antenna arrangement 10 in accordance with the invention. In this arrangement a semi rigid coaxial feed 11 comprises an outer case 12 and an inner wire 13. The outer case 12 is connected to a ground plane 14. The inner wire 13 extends above the ground plane 14 to act as a conductive core 13a. The conductive core 13a is located concentrically within a cylindrical conductive case 16 and is configured as a second semi rigid coaxial section 15. The second semi rigid coaxial section 15 further comprises a top loaded structure in the form of an end cap 17, which is metal. A dielectric material 18 is located within the inner volume of the second semi rigid coaxial section 15. In this particular embodiment the dielectric material 18 is PTFE. A gap G1 is provided between the end of conductive core 13a and the end cap 17. A second gap G2 is provided between the cylindrical conductive case 16 and the ground plane 14. A dielectric material 19 is provided between the cylindrical conductive case 16 and the ground plane 14. In this particular embodiment the dielectric material 19 is air.

FIG. 4 illustrates a cross section schematic representation of a preferred embodiment of the antenna arrangement 20 of the invention. In this arrangement a semi rigid coaxial feed 21 comprises an outer case 22 and an inner wire 23. The outer case 22 is connected to a ground plane 24. The inner wire 23 extends above the ground plane 24 to act as a conductive core 23a. The conductive core 23a is located concentrically within a cylindrical conductive case 26 and is configured as a second semi rigid coaxial section 25. The second semi rigid coaxial section 25 further comprises a top loaded disk 27. A dielectric material 28 is located within the inner volume of the second semi rigid coaxial section 25. In this embodiment the dielectric material 28 is PTFE. A gap G1 is provided between the top loaded disk 27 and the end of conductive core 23a. A gap G2 is provided between the cylindrical conductive case 26 and the ground plane 24. A dielectric material 29 is provided between the cylindrical conductive case 26 and the ground plane 24. In this particular embodiment the dielectric material is air.

For experimental measurements the following dimensions were used for the antenna arrangement. The “top-hat” or disk is 24 mm in diameter, and acts as a short circuit plate on a section of coaxial transmission line 16 mm in length. The coaxial transmission line has a Teflon inner (∈ᵣ=2.1, tan δ=0.0001) of 7 mm in diameter and is fed from another coaxial line entering from the ground plane. The inner wire of this transmission line extends 19 mm in length above the ground plane.

FIG. 5 illustrates the return loss response of the preferred antenna arrangement in accordance with the invention shown in FIG. 4. FIG. 5 shows the measured return loss for antenna arrangement as a function of distance between the lowest point of the cylindrical conductive case 26 and the ground plane 24. The antenna demonstrates a return loss less than 10 dB over the frequency band 2.1-5.1 GHz (or VSWR≦1.92:1 over a 2.3:1 bandwidth) a 3 fold improvement when compared to a conventional wideband λ/4 disk loaded monopole (see FIG. 2). The feed was experimentally optimised for matching bandwidth by adjusting the gap G2 (refer to FIG. 4 set up) to around 6.5 mm. The laboratory prototype and their packaged duplicates indicate the electrical performance was reproducible and that ruggedisation of the design for outdoor use is feasible.

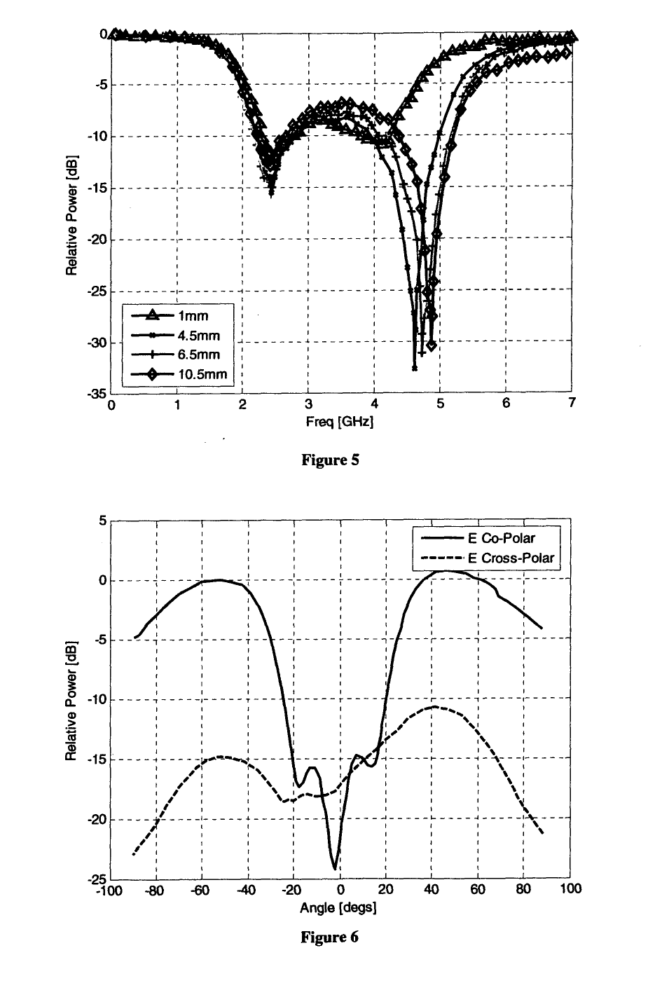

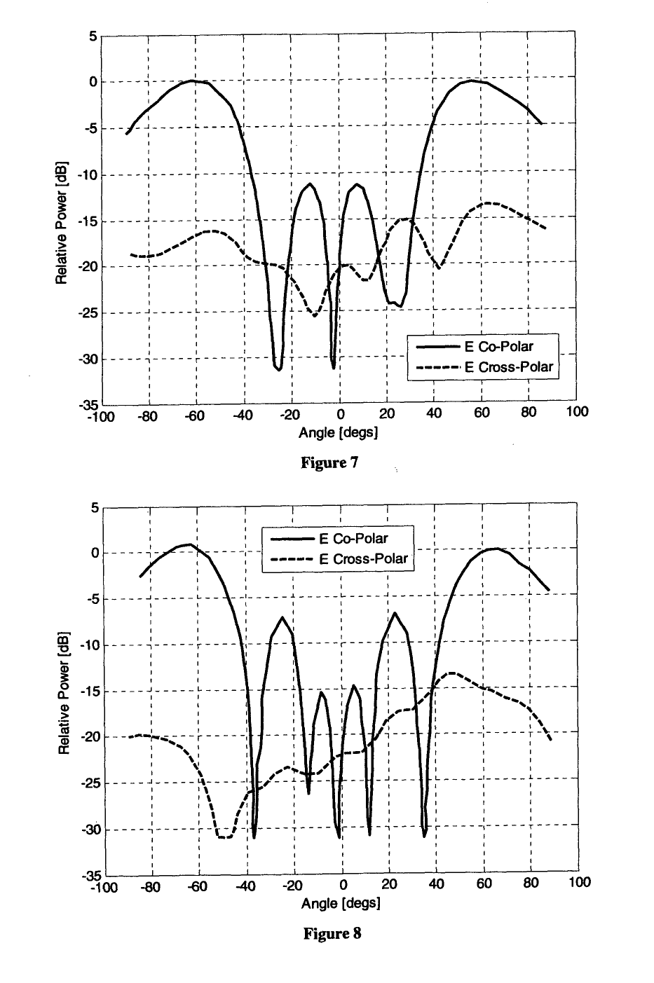

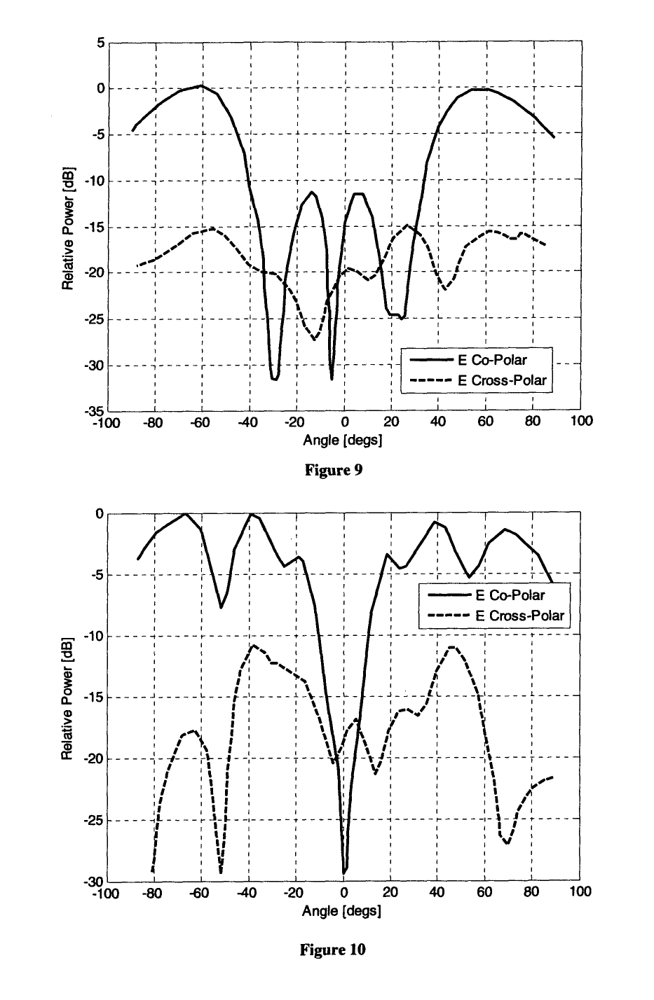

FIGS. 6 to 10 show the radiation patterns of the preferred antenna arrangement as measured at five different frequencies of 2.4, 3.0, 3.6, 4.2, and 4.8 GHz. The antenna radiation pattern is consistent with that intuitively expected i.e. a dipole pattern with radiation maximum on the horizontal plane. The principle E-plane co-polarization and cross-polarization field patterns were measured in an indoor anechoic chamber over +90° to −90° at the five frequencies already described. The results, shown in FIGS. 6-10, indicate that the antenna arrangement has excellent omni-directional performance with low cross-polarization (≦15 dB). Dips in the co-polar field patterns at the centre frequency of 3.6 GHz indicate the onset of side-lobes. The presence of side-lobes is anticipated from the wavelength in relative proportion to the dimension of the disk. There are techniques known in the art which can be applied to reduce side lobes at the expense of introducing loss.

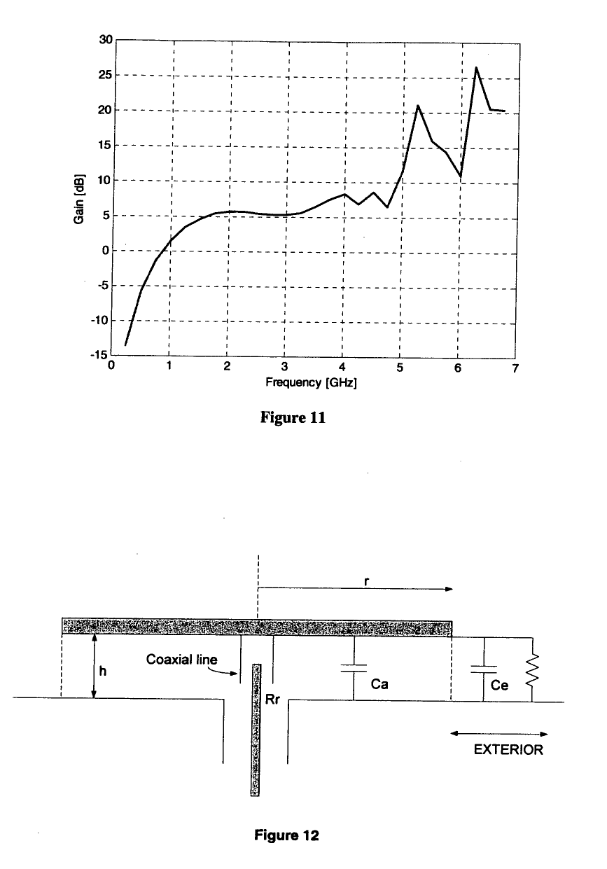

FIG. 11 shows the computer modelled results measured for gain versus frequency for the antenna arrangement shown in FIG. 4, modelled in HFSS. The gain is negative below 800 MHz, with gain plateau of 5 dB from 1.8-4.0 GHz. Above 5 GHz the antenna arrangement shows some resonant gain behaviour. The gain is consistent with the electrical size of the antenna as a function of frequency.

Table 1 shows laboratory measurements of gain at frequencies of 2.1, 3.5, and 4.8 GHz for the preferred antenna arrangement. They are consistent with the HFSS results of FIG. 11.

TABLE 1

| Frequency [GHz] | Antenna Gain [dB] |
|---|---|
| 2.1 | 4.5 |
| 3.5 | 4.8 |
| 4.8 | 5.1 |

The experimental Wheeler cap technique was used to measure radiation efficiency for the antenna arrangement of FIG. 4. This measurement is accomplished by placing the antenna within a sealed shielded metal enclosure that shorts out far-field radiation but does not significantly perturb the near-field. A “metal cap” was constructed from aluminium to behave as a short section of circular waveguide. The cylindrical diameter was 50 cm and height 30 cm. The antenna efficiency η can be calculated using equation (1), where R_{FreeSpace} is the input resistance without the metal cap on and R_{Cap} is the input resistance with the metal cap placed over the antenna:

$$η = \frac{{R}_{FreeSpace} - {R}_{Cup}}{{R}_{FreeSpace}} \times 100 \% \qquad ( 1 )$$

The efficiency for the antenna arrangement of FIG. 4 was found to be around 95±1% at 2.3 GHz.

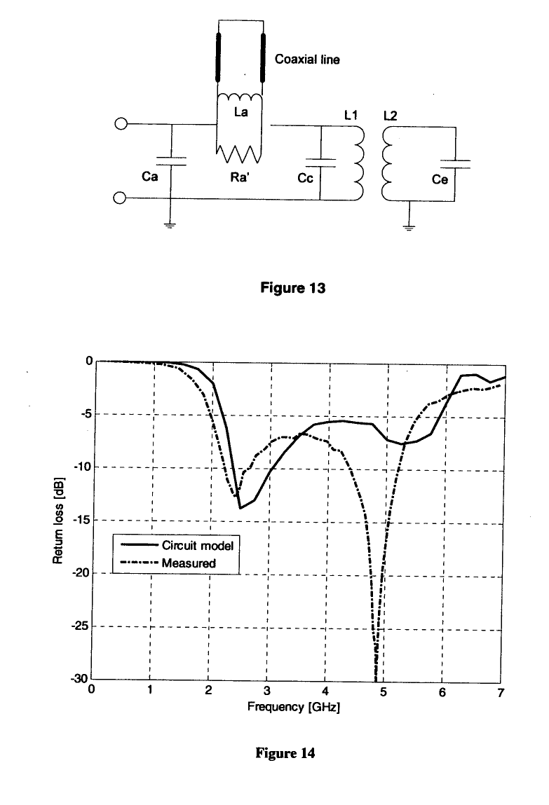

FIGS. 12 and 13, show the physical circuit representation and the equivalent circuit representation of the antenna arrangement of FIG. 4 respectively. The key design feature to wideband performance is a double tuned circuit response achieved by varying G1 G2 (refer to FIG. 4 set up), dielectric materials and the ratio of core radius to case radius. The person skilled in the art of antenna design will understand how variation of these parameters can be used to optimise the double tuned circuit response. The final performance rests on the choice of wideband resonant matching network and keeping the matching networks close to or ideally integral with the antenna (load). Double tuned resonant circuit responses were developed for the antenna arrangement of FIG. 4.

The approximate value for some of the circuit elements has been calculated using the following expressions, where constants have their usual meaning and r and h are related to the antenna geometry shown in FIG. 12.

Ca=∈₀πr²/h (2)

Ca is the internal capacitance of the simple disk loaded monopole.

$$Ce = {ɛ}_{0} r [ 8 + \frac{2}{3} ln ( \frac{1 + 0.8 {( r / h )}^{2} + {( 0.31 r / h )}^{4}}{1 + 0.9 ( r / h )} ) ] \qquad ( 3 )$$

Ce is the external fringing field capacitance of the disk loaded monopole,

Rr=40(2πh/λ)₂ (4)

Where Rr is the radiation resistance in the axial wire of a small antenna.

G=ω²(Ce+Ca)²Rr (5)

G is a parallel conductance term that takes account of the frequency dependence of Rr and

$$Ra = 60 \frac{h}{r} \qquad ( 6 )$$

Ra is the equivalent aperture loading resistance.

$$La = \frac{\sqrt{GRa}}{{ω}^{2} Ce} \qquad ( 7 )$$

While La is the value of inductance across the resistance to give the appropriate frequency variation. The coaxial feed was modelled as a distributed short circuited coaxial component since its equivalent frequency variation would be more exactly followed. The circuit was simulated using the commercial software Ansoft Designer® (available from Ansoft) and FIG. 14 shows a comparison of measurement with theory. Clearly the double tuned circuit response is present in both the measurement and circuit model; though skewed in the higher frequency. It should be noted that the calculated values of lumped reactance values provide only approximate or “first order” values allowing an initial dimensioning and design of antenna arrangement of FIG. 4.

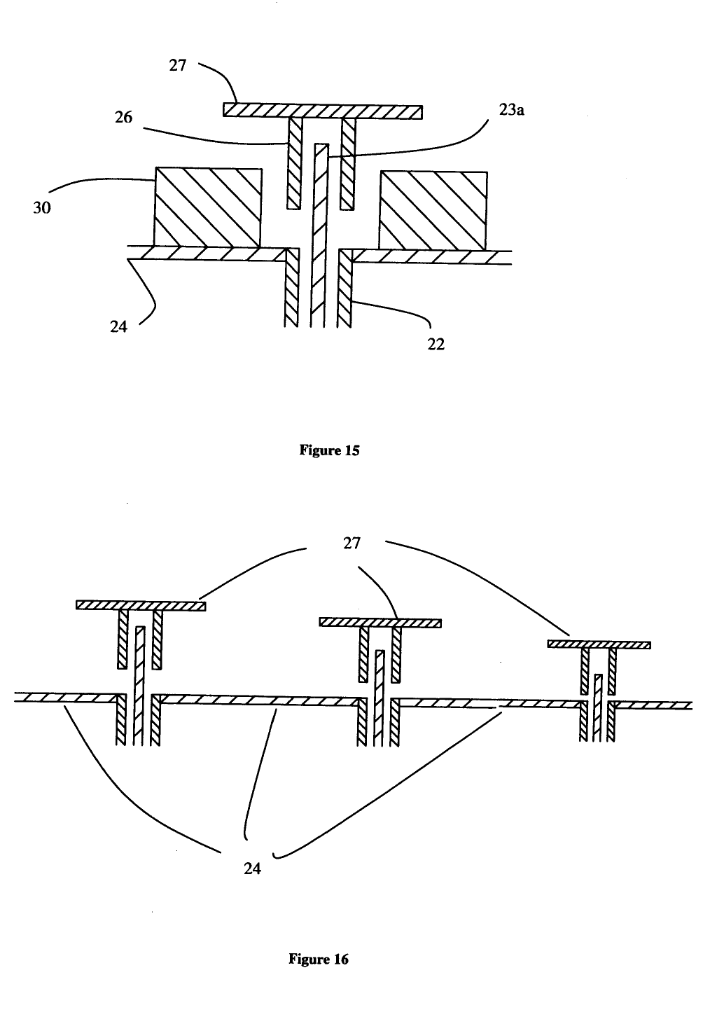

FIG. 15 shows a cross sectional illustration of the preferred invention embodiment of FIG. 4 with rectangular spatial polarisation fins 30. The common features of FIG. 4, the outer case 22, ground plane 24, conductive core 23a, cylindrical conductive case 26 and top loaded disk 27 are indicated. The fins 30 surround the antenna arrangement at regular angular intervals and are constructed of a High Impedance Surface in a radial arrangement around the centre of the antenna.

FIG. 16 shows a cross sectional illustration of the preferred antenna arrangement in a linear array of three antenna. The common features of FIG. 4, the ground plane 24 and top loaded disk 27 are indicated. The gap G1 is varied to provide a very broad stepped bandwidth.

1. An antenna arrangement for use in an UWB network, the antenna arrangement comprising a ground plane, a coaxial feed and an antenna element, wherein the antenna element comprises:
a cylindrical conductive case isolated from the ground plane by a first dielectric material;
a second dielectric material contained within the cylindrical conductive case;
a conductive core extending from the coaxial feed through the first dielectric material and into the second dielectric material; and
a top loaded structure electrically connected to the cylindrical conductive case and electrically insulated from the conductive core,
the antenna element being configured as a shorted coaxial section.

2. An antenna arrangement according to claim 1 wherein the first dielectric material has a permittivity less than or equal to the permittivity of the second dielectric material.

3. An antenna arrangement according to claim 1 wherein the first dielectric material is air.

4. An antenna arrangement according to claim 1 wherein the second dielectric material is PTFE.

5. An antenna arrangement according to claim 1 wherein the top loaded structure is a plate.

6. An antenna arrangement according to claim 5 wherein the top loaded plate is sub divided into a plurality of discrete sections.

7. An antenna arrangement according to claim 1 wherein the antenna element is encased in a third dielectric material.

8. An antenna arrangement according to claim 1 further comprising a plurality of fins positioned radially with respect to the antenna element.

9. An antenna arrangement according to claim 8 wherein the fins comprise High Impedance Surfaces.

10. An antenna array comprising a plurality of antenna arrangements according to claim 1.

11. An antenna array according to claim 10 wherein the plurality of antenna arrangements comprise antenna elements of a plurality of heights.

12. An antenna array according to claim 10 wherein the plurality of antenna arrangements are arranged in a linear configuration.

13. An antenna array according to claim 10 wherein the plurality of antenna arrangements are arranged in a ring shaped configuration.

14. An antenna array according to claim 10 wherein the plurality of antenna arrangements are grounded in a two-dimensional scattering array surface in order to provide an Electromagnetic Band Gap surface.

15. (canceled)
